(19) United States
(12) Patent Application Publication
(10) Pub. No.: US 2004/0256369 A1
(43) Pub. Date: Dec. 23, 2004

(54) Copying welder

(76) Inventor: Akihiro Kondo, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/484,526

(22) PCT Filed: Jul. 18, 2001
(86) PCT No.: PCT/JP01/06225

(51) Int. Cl. B23K 9/12

(52) U.S. Cl. 219/125.12; 219/124.31

(57) ABSTRACT

A tracking welder, which is provided with a carriage traveling in the forward and backward direction, a welding torch mounted on the carriage, a weaving driver for weaving the welding torch, a tracking system for running the carriage along a predetermined welding line, and a welding torch holder for holding the welding torch through the weaving driver and holding the weaving driver adjustably so as to shift the weaving direction of the welding torch around the center of a weaving path. According to this welder, it is possible to carry out fillet welding without causing unbalance of deposit metal between sides on a carriage running face and a tracking face, not only in a case the welding is carried out on a nearly horizontal carriage running face and a nearly vertical carriage running face, but also even in a case the welding is carried out on an inclined carriage running face.

### TECHNICAL FIELD

This invention relates to a tracking welder that is provided with a carriage mounted with a welding torch so as to be possible to weave, and used for performing fillet welding in a corner between carriage running face and tracking face standing on the carriage running face by traveling the carriage.

### BACKGROUND ART

Heretofore as a tracking welder for fillet welding of the aforementioned corner, there has been a welder as shown in FIG. 6, which is provided with a self-propelled carriage 101, a welding torch 102 mounted on the carriage 101, a welding torch holder 103 for holding the welding torch 102 so as to direct the torch 102 toward a corner R between carriage running face P and tracking face Q standing up from the running face P and weave the torch 102 within a plane intersecting with the forward direction of the carriage at nearly right angles, a front side tracking roller 104 disposed at an end (upper end in the figure) on a side of the forward direction of the carriage 101 and projecting toward the tracking face Q, and a rear side tracking roller 105 disposed at an opposite end (lower end in the figure) of the forward direction of the carriage 101 and projecting toward the tracking face Q distantly as compared with the front side tracking roller 104, for example.

In such the welding apparatus 100, the carriage 101 is so designed as to travel without separating from the tracking face Q by making the carriage to travel toward the upper side in the figure at the same time of weaving the welding torch 102 within the plane intersecting with the forward direction of the carriage 101 at nearly right angles in a state of bringing both the tracking rollers 104 and 105 into contact with the tracking face Q, thereby deflecting the heading direction of the carriage 101 toward the tracking face Q, accordingly the fillet welding of the corner R is carried out as maintaining a certain distance between the welding torch 102 and the corner R.

In the aforementioned tracking welding apparatus 100, it is possible to form fillet weld metal in a favorable shape at the corner R between the carriage running face P and the tracking face Q in a case of performing the welding by running the carriage 101 on the nearly horizontal running face P, or on the substantially vertical face P by using magnetic force of a magnet. However, because the welding torch 102 is so structured as to weave within the plane intersecting with the forward direction of the carriage at substantially right angles, there is a problem in that unbalance of thickness is caused in the weld metal in a case of performing the welding by running the carriage 101 on the running face P inclined in the traveling direction, such that a thin part W1 is formed on a side of inclined running face P and a thick part W2 is formed on a side of tracking face Q standing up from the carriage running face P as shown in FIG. 7, and it is not possible to obtain favorable shaped fillet weld metal. Therefore, it is the conventional subject to solve such the problem.

### DISCLOSURE OF THE INVENTION

The present invention has been made in view of the aforementioned problem in the conventional arts, and it is an object to provide a tracking welder, which is possible to form favorable shaped deposit metal at the corner between the carriage running face and the tracking face even if the carriage running face is inclined, of course in a case the carriage running face is nearly horizontal or vertical.

The inventor has found out that the above object are attainable by changing the weaving direction of the welding torch mounted on the carriage as a result of diligently repeating various investigations for attaining the object, and has got to accomplish the present invention.

The tracking welder according to the present invention is characterized by comprising a carriage traveling in forward and backward direction, a welding torch mounted on the carriage, a weaving driver for weaving the welding torch, a tracking system for running the carriage along a predetermined welding line, and a welding torch holder for holding the welding torch through the weaving driver, and holding the weaving driver adjustably so as to shift the weaving direction of the welding torch around the center of a weaving path.

In the first preferred embodiment of the tracking welder in the present invention, the tracking system is characterized by running the carriage along a predetermined welding line in either case of running the carriage in forward or backward direction, in the second preferred embodiment of the tracking welder in the present invention, the tracking system is characterized by comprising an arm provided on the carriage along the traveling direction of the carriage and supported so as to swing around a vertical axis disposed to the carriage at the center thereof, a pair of contactors disposed respectively at both ends of the arm distant equally from the center of the arm and moving in contact with a tracking face standing up from a carriage running face at the time of traveling of the carriage, and a pair of stoppers for restricting the arm in a predetermined swinging range against the carriage, and maintaining the arm in a position where heading direction of the carriage is deflected toward the tracking face as much as a predetermined angle in a state of bringing the pair of contactors of the arm into contact with the tracking face. Further, in the third preferred embodiment of the tracking welder of the present invention, the tracking system is characterized by further comprising a fixing means for maintaining the arm to be restricted by the stoppers.

Furthermore, in the fourth preferred embodiment of the tracking welder of the present invention, the tracking welder is characterized by further comprising a suction system for attracting the carriage toward the carriage running face so as to enable the carriage to travel on the running face.

The tracking welder according to the present invention is provided with the welding torch holder for holding the welding torch through the weaving driver, and adjustably holding the weaving driver so as to shift the weaving direction of the welding torch around the center of the weaving path, therefore satisfactory shaped fillet weld metal is formed at the corner between the carriage running face and the tracking face standing up from the carriage running face, as usual by regulating the position of the weaving driver through the welding torch holder and setting the welding torch so as to weave within the plane intersecting with the forward direction of the carriage at substantially right angles, in a case of performing the welding by running the carriage on the substantially horizontal or vertical face. On the other side, in a case of performing the welding by running the carriage on the inclined face in the traveling direction (at 45 deg. to horizontal, for example), it is avoided to cause unbalance of deposit metal between sides on the inclined carriage running face and the tracking face by regulating the position of the weaving driver through the welding torch holder, and shifting the weaving direction around the center of a weaving path (as much as 45 deg.) so as to coincide the weaving direction with the inclination of the carriage running face (so as to weave the welding torch in the horizontal plane).

Further, in the tracking welder of the first preferred embodiment of the present invention, having the tracking system, it is possible to run the carriage in a state of always directing the welding torch to the corner of the work by this tracking system in either stage of running the carriage in the forward or backward direction. In a case of changing the forward direction of the carriage, tremendous labor is saved, such as replacement of the parts, regulation of the position of the welding torch, and so on.

Furthermore, in the tracking welder of the second preferred embodiment of the present invention, having the tracking system with above-mentioned construction, for example in the stage of carrying out welding by running the carriage in the forward direction, the heading direction of the carriage is reflected toward the tracking face as much as a predetermined angle by turning the arm so as to bring the front side of the carriage close to the tracking face until the arm is restricted by the stopper in a state of contacting one pair of contactors of the arm in this tracking system with the tracking face, and the carriage travels along the tracking face as always pushing the tacking face by running the carriage in such the state, accordingly the distance is maintained in constant between the welding torch and the corner of the work.

In the stage of carrying out welding by running the carriage in the backward direction, the heading direction of the carriage is reflected toward the tracking face as much as a predetermined angle by turning the arm, whose contactors are made in contact with the tracking face, in the opposite direction so as to bring the rear side of the carriage close to the tracking face until the arm is restricted by another stopper, and the carriage travels along the tracking face as always pushing the tacking face by running the carriage in such the state, therefore the distance is maintained constant between the welding torch and the corner of the work similarly to the case of welding in the forward direction.

In this manner, in a case of performing welding after changing the traveling direction of the carriage, operational procedures are completed by merely turning the carriage against the arm of which contactors are made in contact with the tracking face as mentioned above, and the setting operation is very simplified.

In the tracking welder of the third preferred embodiment of the present invention, provided with fixing means of the arm, the arm is prevented to turn in the reverse direction owing to a torch cable from the restricted state by the stopper, in other words, it is certainly prevented to turn the carriage in the direction separating from the tracking face.

Moreover, in the tracking welder of the fourth preferred embodiment of this invention, having the suction system for attracting the carriage toward the carriage running face so as to allow the carriage to travel on the running face, it is possible to hold the carriage on the carriage running face, thereby enabling this welder to also perform filet welding at the corner between the carriage running face and the tracking face of works made of non-magnetic metal, for example, and application fields of this tracking welder come to be increased.

### BRIEF DESCRIPTION OF THE DRAWINGS

FIG. 1 is a side view illustrating movements in the tracking welder according to this invention at the time of weaving the welding torch within the plane intersecting with the traveling direction of the carriage at nearly right angles;

FIG. 2 is a side view of the tracking welder shown in FIG. 1 at the time of shifting the weaving direction of the welding torch as much as approximately 45 deg.;

FIG. 3 is a top plan view of the carriage shown in FIGS. 1 and 2;

FIG. 4 is a front view of the carriage shown in FIG. 3;

FIG. 5 is an explanatory view illustrating a shape of welding metal in a case of performing fillet welding on the inclined running face by using the tracking welder according to this invention;

FIG. 6 is a schematic top view illustrating a state of fillet welding by using the conventional tracking welder;

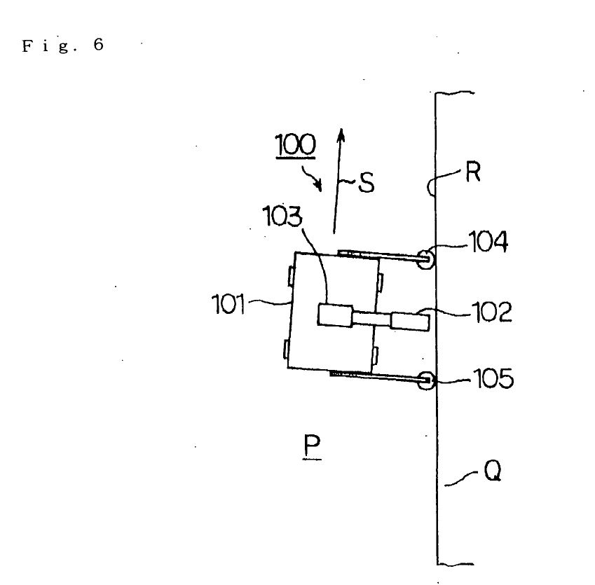

FIG. 7 is an explanatory view illustrating a shape of welding metal in a case of performing fillet welding on the inclined running face by using the conventional tracking welder.

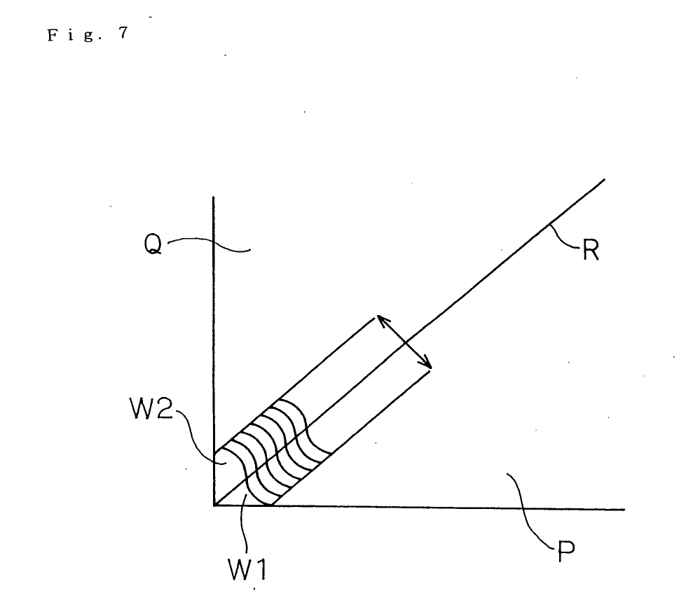

### BEST MODE FOR CARRYING OUT THE INVENTION

The present invention will be described in detail on basis of embodiments thereinafter, however this invention is not limited to these embodiments.

### EXAMPLE 1

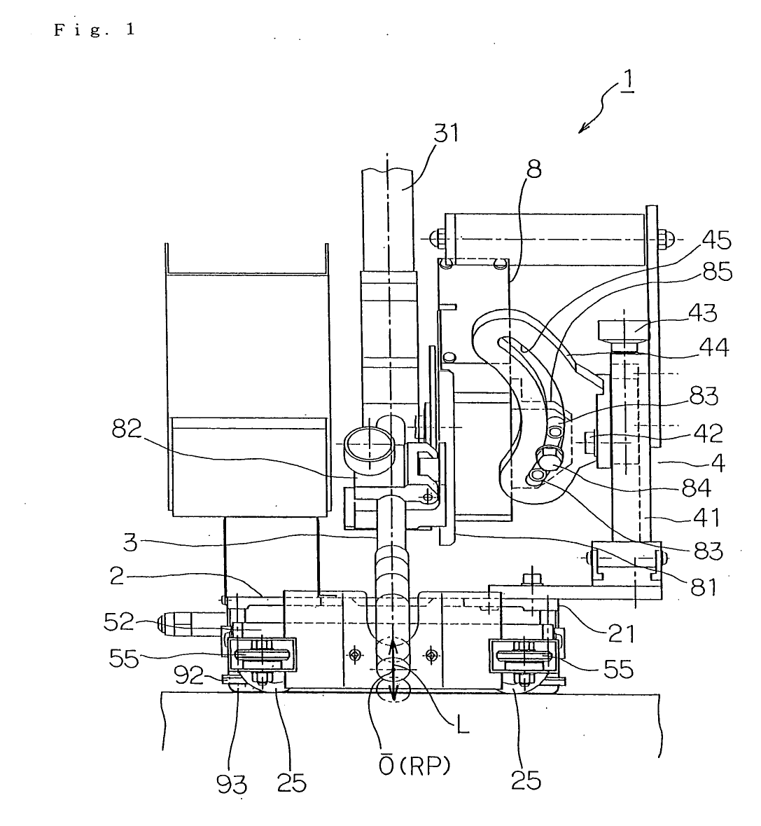

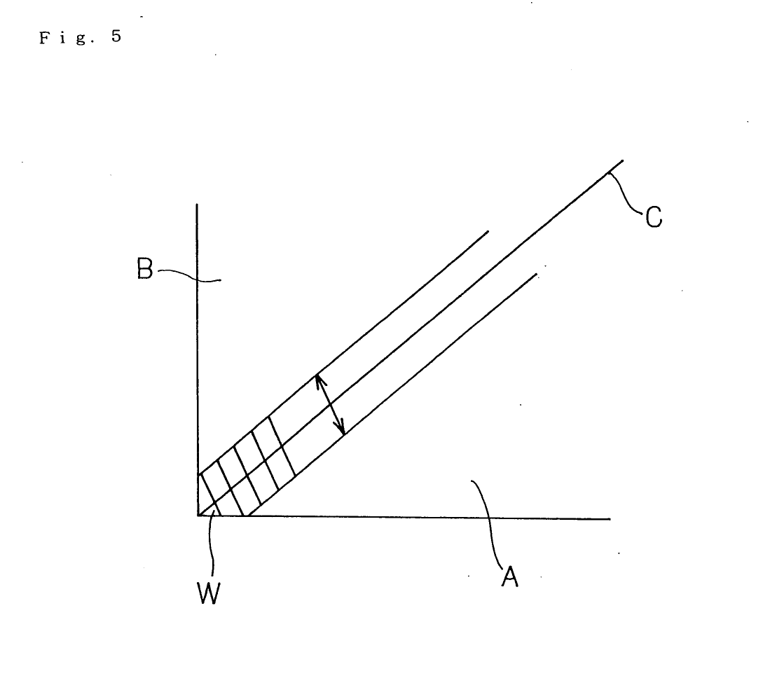

An embodiment of the tracking welder according to this invention is shown in FIG. 1 to FIG. 5.

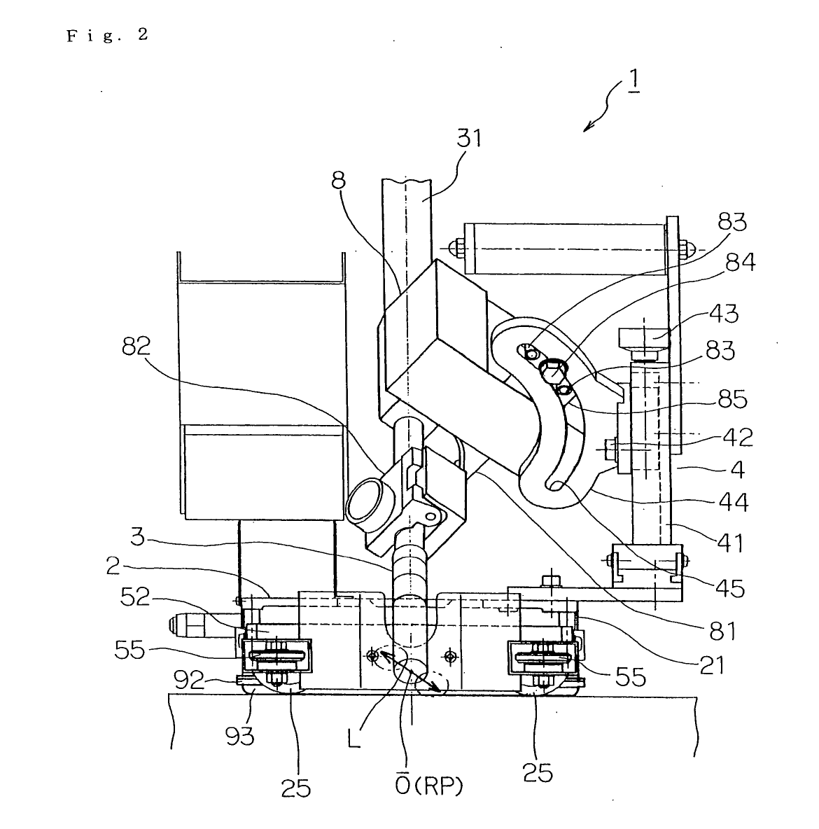

A tracking welder 1 is provided with a carriage 2 in the forward and backward direction, a welding torch 3 mounted on the carriage 2, a weaving driver 8 for weaving the welding torch 3 and a welding torch holder 4 for holding the welding torch 3 through the weaving driver 8 on the carriage 2 shown in FIG. 1 and FIG. 2.

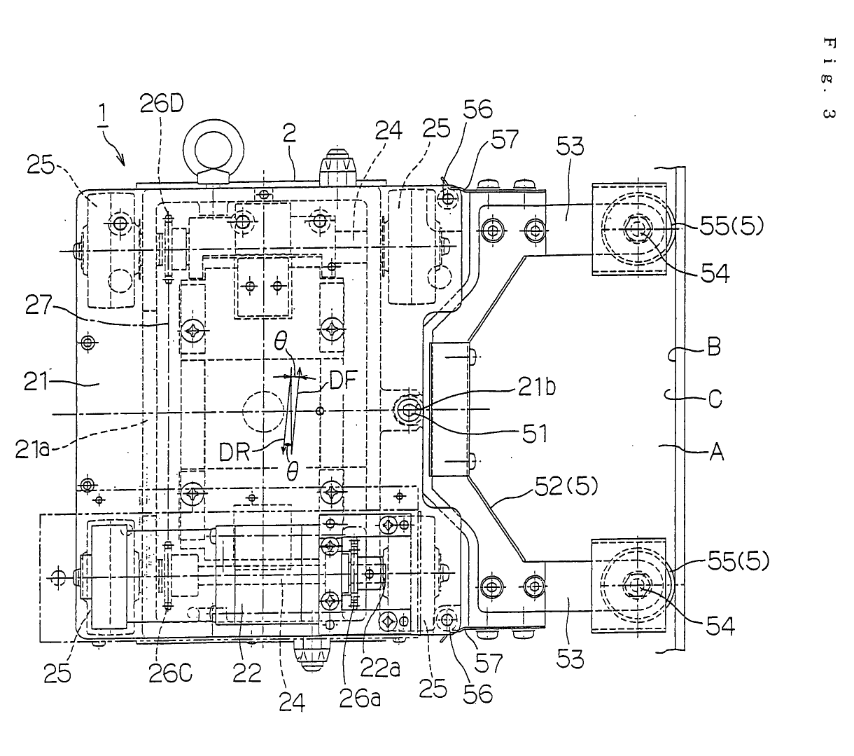

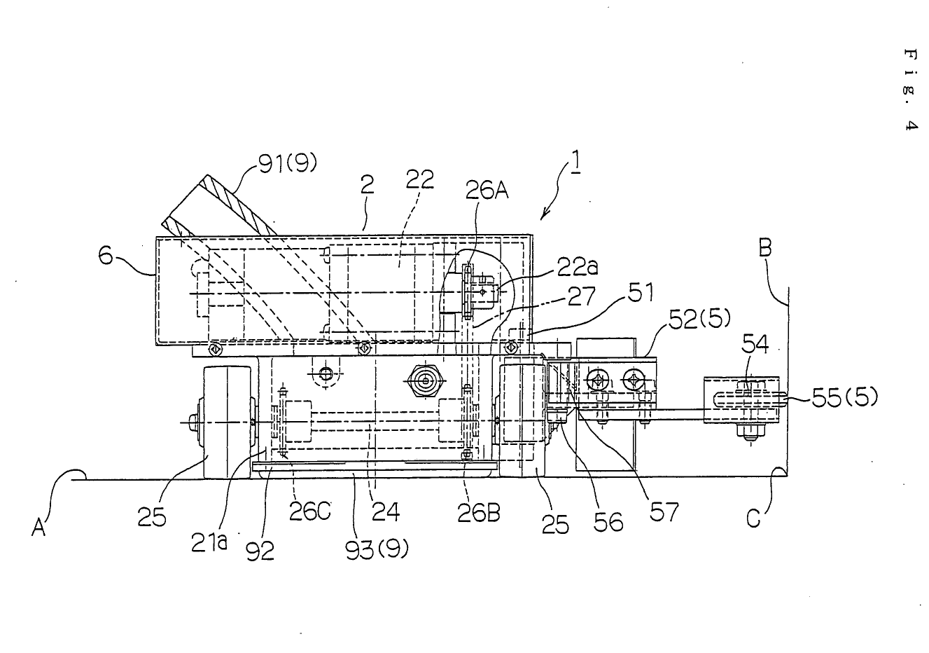

The carriage 2 is provided with a carriage body 21, a geared motor 22 rotatable in the forward and reverse direction and secured on the carriage body 21, wheel axles 24 and 24 on front and rear sides supported to a skirt 21a disposed in the lower part of the carriage body 21 through bearings (not shown), and four rubber wheels 25 in total fixed to respective both ends of the wheel axles 24 and 24 as shown also in FIG. 3 and FIG. 4.

In this carriage 2, rotational power of the motor 22 is transmitted to the rear side axel 24 by stretching a chain 27 between a first sprocket 26A fitted to an output shaft 22a of the motor 22 and a second sprocket 26B fitted to the rear side axel 24, and the rotational power of the motor 22 is also transmitted to the front side axel 24 through the rear side axel 24 by stretching a chain 27 between a third sprocket 26C fitted to the rear side axel 24 and a fourth sprocket 26D fitted to the front side axel 24, thereby actuating all of four rubber wheels 25 as driving wheels and enabling a torch cable 31 to be pulled by the carriage 2.

The welding torch holder 4 is provided with a stand 41 disposed movably in the left and right direction on the carriage body 21, and a holder plate 44 attached rotatably to the stand 41 through a bolt 42 positioned in parallel to the traveling direction of the carriage 2 and movable in the vertical direction by rotational operation of vertical bolt 43. The weaving driver 8 is provided with a moving arm 81 for performing weaving action at the time of actuation, and a torch clamp 82 disposed at the top end of the moving arm 81 for fixing the welding torch 3 movably in the axial direction in a state of directing the torch 3 to a corner C between a carriage running face A and a tracking face B standing up from the carriage running face A.

In this case, the holder plate 44 of the welding torch holder 4 is formed with an arc-shaped hole 45, and the weaving driver 8 is further provided with a connecting bracket 85 having two rollers 83 fitting movably into the arc-shaped hole 45 and secured to the holder plate 44 by tightening a bolt 84. The center RP of curvature of the arc-shaped hole 45 in the holder plate 44 is made so as to substantially coincide with the weaving center O of the welding torch 3 held through the clamp 82 of the weaving driver 8.

In such the manner, the weaving path L of the welding torch 3 is so designed as to be shifted around the weaving center O by moving the weaving driver 8 into the situation shown in FIG. 2 from the situation shown in FIG. 1 along the arc-shaped hole 45 of the holder plate 44 after loosening the bolt 84. The weaving path L shown in FIG. 1 is adopted in a case of performing welding by running the carriage 2 on the nearly horizontal or vertical face A, and the weaving path L shown in FIG. 2 is introduced in a case of performing welding by running the carriage 2 on the inclined face A (inclination angle of about 45 deg. in FIG. 2).

The tracking welder 1 is further equipped with a tracking system 5 for running the carriage 2 along the tracking face B.

The tracking system 5 is provided with an arm 52 disposed along the traveling direction of the carriage 2 and connected to a vertical axial hole 21b positioned at the center of the carriage body 21 in the traveling direction so as to freely swing around the axial hole 21b through a hinge shaft 51 at the center thereof, tracking rollers (a pair of contactors) 55, 55 supported through a pivot shafts 54, 54 at respective ends of bracket 53, 53 projecting from both ends of the arm 52 toward the opposite side of the carriage body 21, and pins (stoppers) 56, 56 disposed at respective front and rear ends of the carriage body 21 within a swinging range of the arm 52 for restricting the movement of the arm 52, each of the tracking rollers 55, 55 is disposed at the same distance from the center of the arm 52.

In the tracking system 5, heading direction DF of the carriage 2 is deflected toward the tracking face B as much as a predetermined angle θ (2˜3.5 deg.) by restricting swinging movement of the arm 52 of which tracking rollers 55 and 55 are made in contact with the tracking face B through the pin 56 disposed at the front side of the carriage body 21 in the stage of running the carriage in the upward direction in FIG. 3. In the other side, heading direction DR of the carriage 2 is deflected toward the tracking face B as much as a predetermined angle θ by restricting the swinging movement of the arm 52 of which tracking rollers 55 and 55 are made in contact with the tracking face B through the pin 56 disposed at the rear side of the carriage body 21 in the stage of running the carriage in the downward direction in FIG. 3.

In this case, the carriage body 21 is provided with engaging springs 57, 57 as fixing means, in the vicinity of the respective pins 56, 56 on the front and rear sides thereof for engaging with the bracket 53 of the arm 52 on the side in contact with the pin 56, whereby the arm 52 is so structured as to be prevented to be pulled by the torch cable 31 and swing in the separating direction from the pin 56.

Furthermore, the tracking welder 1 is equipped with a suction system 9 for attracting the carriage 2 toward the carriage running face A so as to allow the carriage 2 to travel on the running face A.

The suction system 9 is provided with a suction sleeve 91 disposed to the carriage body 21 of the carriage 2 and communicating with the inside of the skirt 21a, a packing 93 made of silicon rubber or so, attached on the lower end of the skirt 21a through a bottom plate 92 and set in near contact with the carriage running face A, and a vacuum pump (not shown) working as a suction source and connected with the suction sleeve 41 through a hose. The suction system 9 is designed to attract the carriage 2 so that the carriage 2 may travel on the carriage running face A by actuating the vacuum pump and sucking inner air of the skirt 21a of the carriage body 21.

In the case of performing welding on the substantially horizontal or vertical carriage running face A using the aforementioned tracking welder 1, the heading direction DF of the carriage 2 is set in the deflected state toward the tracking face B as much as predetermined angle θ, by turning the carriage 2 around the hinge shaft 51 supporting the arm 2 and making the pin 56 on the front side of the carriage body 21 in contact with the arm 52 after making the one pair of tracking rollers 55, 55 of the tracking system 5 to be in contact with the tracking face B, first of all.

Next, the welding torch 3 is set to an angle of about 45 deg. from the carriage running face A by turning the holder plate 44 around the bolt 42, the projecting position of the welding torch 3 is adjusted by the clamp 82 at the state of directing the welding torch 3 to the corner C between the carriage running face A and the tracking face B, and then the welding torch 3 is set so as to weave within a plane intersecting with the forward direction of the carriage at substantially right angles (the weaving path L is set as shown in FIG. 1) by regulating the position of the weaving driver 8.

When welding is started at the same time of running the carriage 2 set as described above in the forward direction by supplying electric power to the motor 22 according to the on operation of a switch on a cover 6 provided to the carriage 2 after attracting the carriage 2 toward the carriage running face A so as to be allowed to travel on the running face A by actuating the vacuum pump and sucking inner air of the skirt 21a of the carriage body 21, the carriage 2 comes to be propelled in the direction (heading direction) DF deflected toward the tracking face B as much as the predetermined angle θ, namely the carriage 2 comes to travel always in a state of pushing the tracking face B, so that the distance between the welding torch 3 and the corner C is maintained in constant during the welding. Consequently, fillet welding is completed at the corner C without displacement and deviation of the deposit metal and favorable shaped fillet weld metal W is formed at the corner C between carriage running face A and tracking face B as in the past.

On the other side, in a case of carrying out fillet welding at the corner C between carriage running face A and tracking face B by running the carriage 2 in the backward direction along the tracking face B, the carriage 2 is turned in the direction opposite to the above around the hinge shaft 51 after stopping the carriage and the pin 56 on the rear side of the carriage body 21 is made contact with the arm 52, thereby setting the carriage 2 in a state where the heading direction DR of the carriage 2 is deflected toward the tracking face B as much as the predetermined angle θ. In such the state, starting the welding by running the carriage 2 in the backward direction according to the changeover operation of the switch, the carriage 2 travels as it always pushes the tracking face B and the distance between the welding torch 3 and the corner C is maintained in constant also in this case.

In a case of performing the welding on the inclined carriage running face A (on the face inclined at 45 deg. in the traveling direction in this example), the weaving path L of the welding torch 3 is shifted around the weaving center O as much as about 45 deg. so as to coincide with the inclination of the carriage running face A (so as to agree with the horizontal plane) by moving the weaving driver 8 into the position shown in FIG. 2 from the position shown in FIG. 1 along the arc-shaped hole 45 of the holder plate 44 after loosening the bolt 84. Whereby the deposit metal W is substantially uniformized between sides on the inclined carriage running face A and the tracking face B.

Accordingly, in this tracking welder 1, it is possible to form favorable shaped deposit metal at the corner C between the carriage running face A and the tracking face B even if the carriage running face A is inclined, not to mention in a case the carriage running face A is nearly horizontal or vertical.

Further in this tracking welder 1, it is possible to always direct the welding torch 3 to the corner C at the same time of holding constantly the distance from the corner C in either case of performing aforementioned fillet welding by running the carriage 2 in the forward or backward direction, so that the operational procedures are completed by merely turning the carriage 2 against the arm 52 of which one pair of tracking rollers 55, 55 are made in contact with the tracking face B as mentioned above in the case of performing welding after changing the forward direction of the carriage 2, tremendous labor is saved, such as replacement of the fittings and regulation of the position of the welding torch 3, and the setting operation is very simplified.

Moreover, in this tracking welder 1, the engaging springs 57 are provided to the front and rear sides of the carriage body 21 for engaging to the bracket 53 of the arm 52 on the side being in contact with the pin 56, whereby the arm 52 is prevented to swing in the direction separating from the pin 56 even in a case of being pulled by the torch cable 31.

Furthermore, in this tracking welder 1, which is provided with the suction system 9 for attracting the carriage 2 toward the carriage running face A so as to allow the carriage to travel on the face A, it is possible to also perform the filet welding at the corner between the carriage running face and the tracking face of works made of nonmagnetic metal, for example, and application fields of this tracking welder 1 come to be increased.

### INDUSTRIAL APPLICABILITY

As described above, in the tracking welder according to the present invention, providing the welding torch holder for holding the welding torch through the weaving driver, and adjustably holding the weaving driver so as to shift the weaving direction of the welding torch around the center of the weaving path, it is possible to perform the fillet welding without causing unbalance of deposit metal in amount between sides on the inclined carriage running face and the tracking face even in a case of performing the welding on the inclined carriage running face, not to mention in a case of performing on the substantially horizontal or vertical face.

Also, in the preferred embodiment of the tracking welder according to the present invention, providing the tracking system, it is possible to run the carriage in a state of always directing the welding torch to the corner of the work without tremendous labor, such as replacement of the parts, regulation of the position of the welding torch, and so on in either stage of running the carriage in the forward or backward direction.

Further, in the other preferred embodiment of the tracking welder according to the present invention, providing the tracking system with the aforementioned construction, it is possible to simplify the setting operation at the time of performing the welding after changing the forward direction of the carriage.

Moreover, in the other preferred embodiment of the tracking welder according to the present invention, providing the fixing means for the arm, it is possible to certainly prevent the carriage to be turned in the direction separating from the tracking face even when the carriage is pulled by the torch cable, which is suspended from or hauled by the carriage.

Furthermore, in the other preferred embodiment of the tracking welder according to the present invention, providing the suction system for attracting the carriage toward the carriage running face so as to allow the carriage to travel on the running face, it is possible to increase the applicable fields of this tracking welder.

What is claimed is:

1. A tracking welder comprising:
a carriage traveling in forward and backward direction; a welding torch mounted on the carriage;
a weaving driver for weaving the welding torch;
a tracking system for running said carriage along a predetermined welding line; and
a welding torch holder for holding said welding torch through the weaving driver, wherein said welding torch holder holds said weaving driver adjustably so as to shift weaving direction of the welding torch around the center of a weaving path.

2. A tracking welder as set forth in claim 1, wherein said tracking system is so designed as to run the carriage along a predetermined welding line in either case of running said carriage in forward or backward direction.

3. A tracking welder as set forth in claim 2, wherein said tracking system comprises;
an arm provided on the carriage along traveling direction of said carriage and supported so as to freely swing around a vertical axis disposed to the carriage at the center thereof;
a pair of contactors disposed respectively at both ends of the arm distant equally from the center of said arm, and moving in contact with a tracking face standing up from a carriage running face at the time of traveling of the carriage; and
a pair of stoppers for restricting a swinging range of the arm against the carriage,
said stoppers maintain the arm in a position where heading direction of said carriage is deflected toward the tracking face as much as a predetermined angle in a state of bringing said pair of contactors of the arm into contact with said tracking face.

4. A tracking welder as set forth in claim 3, wherein said tracking system is further provided with a fixing means for maintaining said arm to be restricted by said stoppers.

5. A tracking welder as set forth in claim 1, wherein said welder is further provided with a suction system for attracting the carriage toward the carriage running face so as to enable the carriage to travel on the running face.
